(19) United States
(12) Patent Application Publication
(10) Pub. No.: US 2006/0218613 A1
(43) Pub. Date: Sep. 28, 2006

(54) System and method for acquiring on-line content via wireless communication device

(76) Inventor: William Jackson Bushnell, St. Charles, IL (US)

Correspondence Address: Lucent Technologies Inc.;Docket Administrator - Room 3J-219, 101 Crawfords Corner Road, Holmdel, NJ, 07733-3030, US

(21) Appl. No.: 11/086,104

(22) Filed: Mar. 22, 2005

(51) Int. Cl. H04N 7/173; H04N 7/16

(52) U.S. Cl. 725/109; 725/112; 725/110; 725/62

(57) ABSTRACT

A wireless subscriber is able to purchase music or other content from an on-line content provider. The subscriber sends a Short Message Service (SMS) message to an on-line content server indicating a desire to purchase content currently playing on a specified radio station. The on-line content server validates that the end user has a valid account. The on-line content server then queries the specified radio station web server to identify the specific content (e.g., title and artist of a current song). The on-line content server formats a SMS message to the wireless subscriber, which contains the title of the song and the artist and identifies various purchase options. The subscriber responds with an SMS message that confirms a particular purchase option and the requested content is downloaded to the subscriber's PC or wireless communication device.

### FIELD OF THE INVENTION

This invention relates generally to the field of wireless communication networks and, more particularly, to providing network support for acquiring music or other content from an on-line content provider via a wireless communication device.

### BACKGROUND OF THE INVENTION

Today several companies provide on line web sites at which users can purchase or rent content such as songs, music videos and books on tape. Some exemplary web sites of this type include, without limitation, iTunes, MusicMatch Jukebox and Napster. Companies providing web sites that offer on-line content will hereinafter be referred to as “on-line content providers.” Generally, such sites require that the end user set up an account with the on-line content provider and provide credit card information or the like so as to enable purchases to be charged to the account. Thereafter, the user is able to browse lists of available content and selectively preview and purchase or rent selected content (e.g., songs) for download to the user's personal computer (PC). From the PC, the song files can be transferred to a portable music player (e.g. Apple iPod). The song files may also be arranged in groups called playlists which, depending on the business model of the content provider and applicable copyright restrictions, may be transferred or “burned” onto a compact disc (CD) or transferred to the portable music player.

One drawback with this arrangement is that the user must operate their PC to find and purchase particular content on the on-line content provider web site, and the process of finding certain content can be difficult at times. In the case of songs, for example, it can be difficult for a user to find a song if the user does not know the title and/or artist of the song. Moreover, the user may be away from their PC at such time, if ever, that they become aware of the title and/or artist. For example, persons frequently hear a song that they would like to purchase while they are away from their PC (e.g., while listening on their car radio) and, even if the title and/or artist is announced on the radio, the person is unable to purchase the song until they return to their PC. This can result in lost sales opportunities for the on-line content provider since persons may lose their desire to purchase the song or become distracted with other matters by the time they reach their PC.

Even persons that remain motivated to purchase a particular song when they return to their PC may become discouraged if they don't know the title and/or artist of the song. For example, persons having heard a song on the radio that they wish to purchase but not knowing the title and/or artist may not even attempt to search for the song when they return to their PC. Today many broadcast radio stations have web sites that list the titles and artists of songs that they play, and thus it is possible for a user having heard a song on the radio to go to the station's web site to determine the title and artist. However, many users may not be aware of this service and even those that know the service exists may be unwilling to use it or may attempt to use it but still be unable to determine the title and/or artist. This also can result in lost sales opportunities for the on-line content provider since persons may become discouraged and abandon their search without purchasing the song. Still further, even persons that know or are able to determine the title and/or artist of a song may not wish to take the time and effort to access the on-line content provider web site and enter the name of the song and artist to purchase the song.

### SUMMARY OF THE INVENTION

These problems are addressed and a technical advance is achieved in the art by a feature that allows users to access and purchase on-line content (including, without limitation, songs) via a wireless communication device (e.g., mobile phone) while they are away from their PC. In such manner, for example, a user may purchase songs heard on the radio without the need for the user to access an on-line content provider web site. In one embodiment, the user may purchase the song without specifying the title and artist of the song. In another embodiment, the user (or wireless communication device) may specify the title and artist of the song.

In one embodiment, there is provided a method for a subscriber of an on-line content service to access and purchase on-line content corresponding to broadcast programming. The method may be exercised, for example, to access and purchase a song played on the radio, even though the subscriber does not know the title and artist of the song. The method is performed using a wireless communication device in communication with an on-line content server. The wireless communication device sends a message to the on-line content server including source (e.g., radio station) and timing information (e.g., time the programming was heard) associated with the programming that the subscriber is listening to. Responsive to the message, the wireless communication device receives indicia of one or more items of on-line content identified by the on-line content server based on the source and timing information. The wireless communication device may select purchase and delivery options associated with the on-line content and cause on-line content corresponding to a selected purchase option to be delivered to itself or another specified delivery device.

In another embodiment, there is provided a corresponding method performed by an on-line content server to support the access and purchase of on-line content corresponding to broadcast programming using a wireless communication device. The on-line content server receives a message from the wireless communication device including source (e.g., radio station) and timing information (e.g., time the programming was heard) associated with the programming that the subscriber is listening to. Based on the source and timing information, the on-line content server identifies one or more items of on-line content corresponding to the broadcast programming and sends indicia of the on-line content to the wireless communication device. The on-line content server may offer purchase and delivery options associated with the on-line content. The on-line content server sends on-line content corresponding to a selected purchase option to the wireless communication device or another specified delivery device.

In still another embodiment, there is provided a method for a subscriber of an on-line content service to access and purchase a song played on the radio by specifying the title and artist of the song. The method is performed using a wireless communication device in communication with an on-line content server. The wireless communication device sends a message to the on-line content server including title and artist information associated with the song that the subscriber is listening to. Responsive to the message, the wireless communication device receives indicia of one or more items of on-line content identified by the on-line content server based on the title and artist information. The wireless communication device may specify purchase and delivery options associated with the on-line content.

### BRIEF DESCRIPTION OF THE DRAWINGS

The foregoing and other advantages of the invention will become apparent upon reading the following detailed description and upon reference to the drawings in which:

FIG. 1 is a block diagram of a communication system that supports acquiring music or other content from an on-line content provider via a wireless communication device according to an embodiment of the present invention;

FIG. 2 is a flowchart showing a method for acquiring music or other content from an on-line content provider via a wireless communication device without specifying the title/artist according to an embodiment of the present invention; and

FIG. 3 is a flowchart showing a method for acquiring music or other content from an on-line content provider via a wireless communication device specifying the title/artist according to an embodiment of the present invention.

### DESCRIPTION OF THE PREFERRED EMBODIMENT(S)

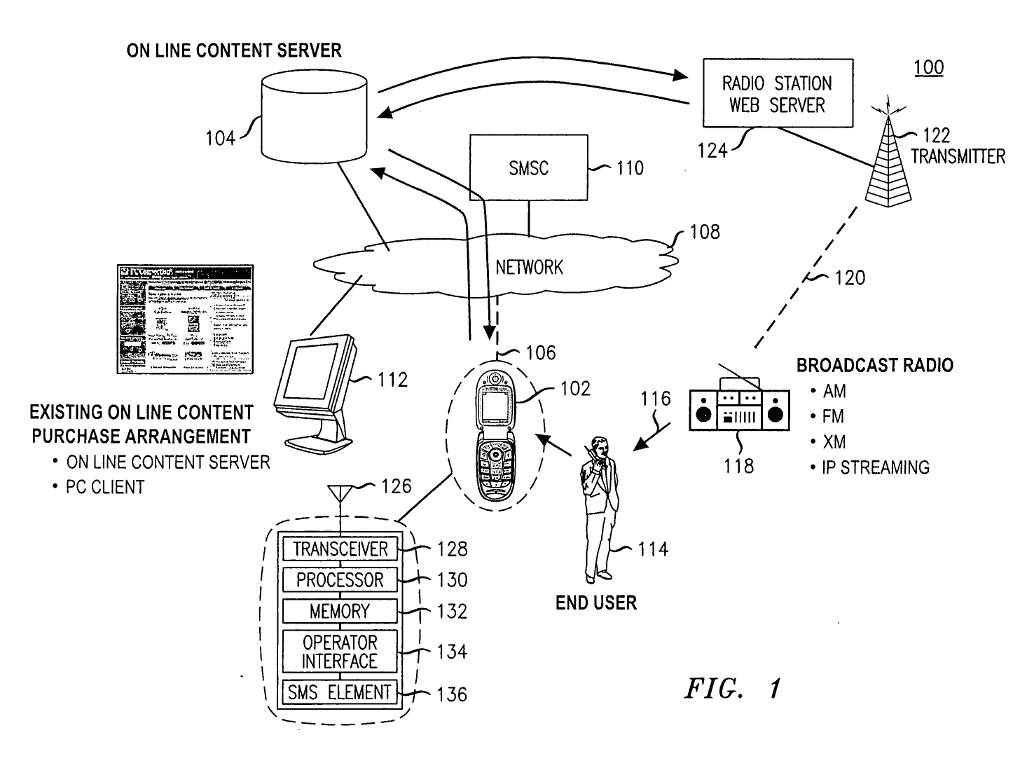

FIG. 1 depicts a communications system 100 that supports acquisition of music or other content from an on-line content provider via a wireless communication device. A wireless communication device 102 is operably connected to an on-line content server 104 via a radio link 106 and a network 108. The network 108 may comprise, for example, the Internet or a managed IP network or an SS7 signaling network. A short message service center (SMSC) 110 supports short message service (SMS) communications between the wireless communication device 102 and on-line content server 104 via the network 108. Typically, in the case of SMS communications, the network 108 comprises an SS7 signaling network. Alternatively or additionally, a Multimedia Messaging Service Center (MMSC) (not shown) may be provided to support multimedia communications between the wireless communication device 102 and on-line content server via the network 108. Typically, in the case of MMS communications, the network 108 comprises an IP network.

The wireless communication device 102 may comprise, without limitation, a mobile phone, laptop computer, personal digital assistant (PDA) or the like. The wireless communication device includes an antenna 126, radio transceiver 128, processor 130, memory 132, operator interface 134 and SMS element 136 (or alternatively, MMS element). As will be appreciated, the various elements are functional elements that may reside in one or more physical structures within or remote from the wireless communication device 102.

The radio transceiver 128 is coupled to the antenna 126 and processor 130 to enable the communication device to exchange information (e.g., voice, video, data, short messages, etc.) via the radio link 106 to the network 108. The radio link 106 is a functional link that supports wireless communication between the wireless communication device 102 and network 108. As will be appreciated, the radio link may be implemented using air interface technologies including but not limited to, CDMA, TDMA, GSM, UMTS, IEEE 802.11 (e.g., WiFi) and IEEE 802.16 (e.g., WiMAX).

The processor 130 comprises a microprocessor and digital signal processor for controlling the various elements of the communication device and for communicating via the radio link 106. The memory 132 stores software algorithms and data used by the processor 130 during operation of the communication device. The operator interface 134 comprises one or more input devices including, for example, microphone, camera, keypad, touchscreen, etc. that enables an operator to input information, select options, perform tasks and the like; and one or more output devices such as a display screen and/or speaker for communicating or displaying information to the operator. The SMS element 136 is a functional element that enables the communication device 102 to send and receive SMS messages.

As shown, a computer 112 (e.g., PC) is connected to the network 108, and hence the on-line content server 104. Presuming a user associated with the computer 112 has set up an appropriate account with the on-line content provider, the computer is able to access the on-line content server 104 to preview and/or purchase selected content (e.g., songs) from the on-line content provider. Thereafter, purchased content is downloaded from the content server 104 to the PC; and from the PC, the song files can be transferred to a portable music player (not shown). This method of accessing and purchasing on-line content from a PC is well known.

The present invention provides a manner for a subscriber 114 to access and purchase on-line content from an on-line content provider by means of a wireless communication device (e.g., device 102), such that a subscriber 114 can access and purchase on-line content while they are away from their PC. For example, the subscriber may purchase songs heard on a radio broadcast. The subscriber 114 hears radio content 116 from a radio player (“radio”) 118. As will be appreciated, the radio 118 may comprise generally any device operable to receive and playback broadcast radio signals comprising, without limitation, AM, FM, XM or IP streaming radio. In the case of streaming radio, the wireless device 102 or computer 112 may be used to receive and playback radio programming. As shown, the radio 118 receives over-the-air radio signals 120 from radio transmitter 122. The radio transmitter 122 transmits radio station programming from a radio station (not shown). The radio station includes a web server 124 and associated web site that lists programming information including, for example, titles and artists of songs, talk radio programming and the like that has been broadcast, is presently broadcast or is scheduled for broadcast.

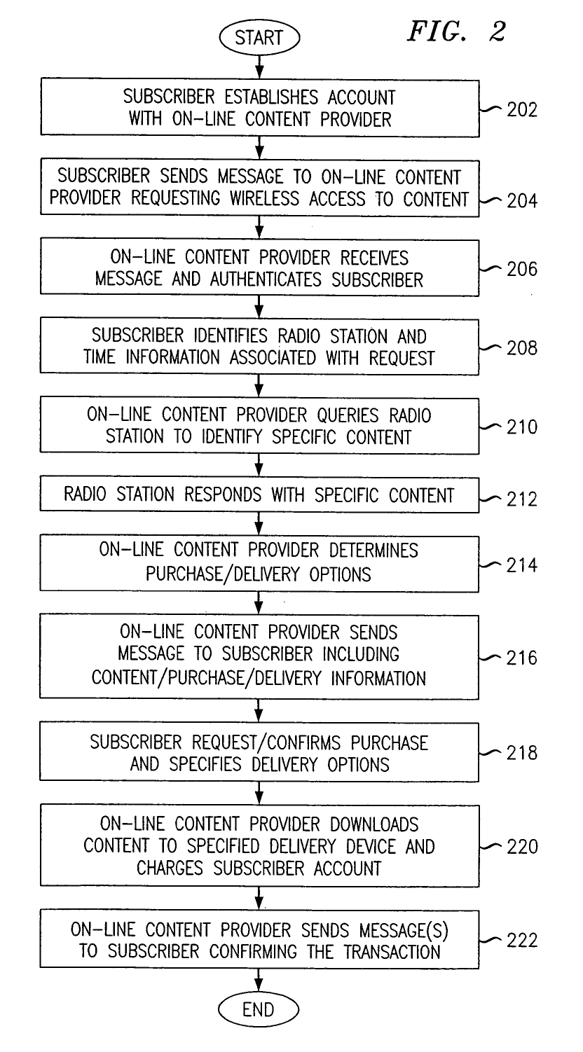

As will be described in greater detail in relation to FIG. 2, the subscriber can access and purchase content heard on the radio by sending a message from the wireless communication device 102 to the content server 104 without specifying the particular radio content (e.g., the title and artist of a song, or radio program played at the time of the message). Responsive to the message, the content server 104 queries the radio station web server for particular radio content (for example, the title and artist of a song, or radio program played at the time of the message) and then downloads the content (or makes the content available for download) to a specified delivery device of the subscriber. In such manner, the subscriber is able to purchase content heard on the radio without accessing and searching an on-line content provider web site and without knowing the particular radio content.

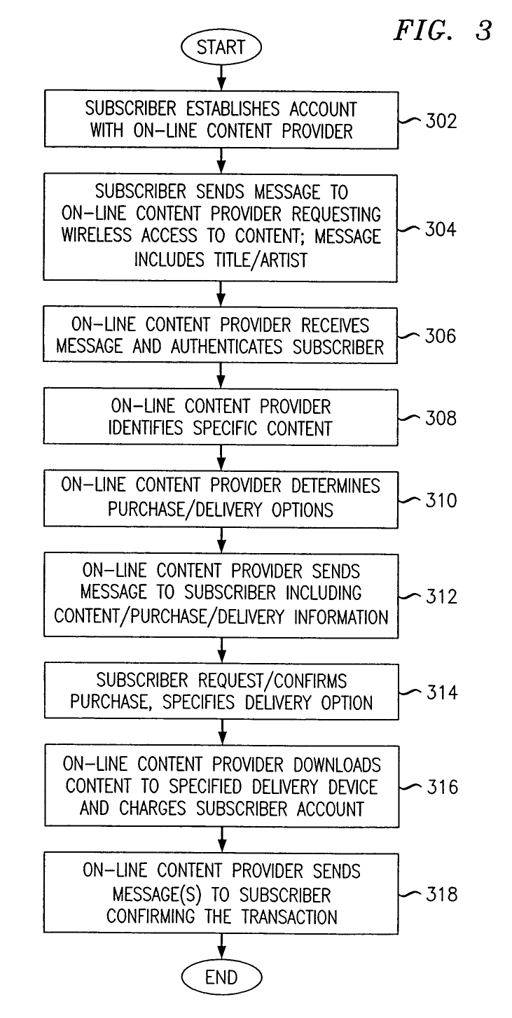

Alternatively, as will be described in greater detail in relation to FIG. 3, the subscriber can access and purchase content heard on the radio by sending a message from the wireless communication device 102 to the content server 104 that specifies the particular radio content (e.g., title and artist of a song, or radio program). In one embodiment, the wireless communication device captures information embedded in the radio broadcast to identify the title and artist and forwards this information to the content server 104. Alternatively, such information can be manually entered by the subscriber into the wireless communication device and forwarded to the content server 104. To elaborate further, many radio stations broadcast information identifying the title and artist of a song while the song is being played. Certain radios can capture this information and display the title and artist to the listener. The present invention contemplates that such title and artist information can be captured by the wireless communication device, either automatically or manually entered by the listener and this information forwarded to the content server. Responsive to the message, the content server 104 downloads the content (or makes the content available for download) to a specified delivery device of the subscriber. In such manner, the subscriber is able to purchase content heard on the radio without accessing and searching an on-line content provider web site.

FIG. 2 is a flowchart of a method that may be implemented in a communication system of the type shown in FIG. 1 for a subscriber 114 to acquire music or other content from an on-line content provider via a wireless communication device 102 without specifying the title/artist.

The method presumes at block 202, that the subscriber 114 subscribes to an on-line content service, thereby establishing an account with an on-line service provider that enables the subscriber to access and purchase on-line content from the wireless communication device 102. In one embodiment, the on-line service allows the subscriber to request the purchase of content via SMS messages. For security the subscriber will specify the telephone number of the wireless communication device 102 that will launch the SMS messages. In one embodiment, the on-line content server 104 is equipped with software that allows it to receive SMS messages and to launch SOAP based XML information requests to a prescribed list of radio station web sites. The on-line content server 104 is also equipped to receive the response to those messages and to format SMS responses to the end user.

At step 204, the subscriber 114 initiates one or more SMS messages to the on-line content server 104 to request access to content. In one embodiment, the request indicates a request to access content that is currently playing on a specified radio station so as to enable purchase or “preview” of the content prior to purchase. Alternatively or additionally, the request may specify content that was previously played or will be played in the future. In the case of a song request, the request need not specify the title or artist of the song. In one embodiment, the SMS messages include indicia of the sending device 102, such as sending address, MIN number, telephone number or the like.

At step 206, the on-line content server 104 receives the message and authenticates the subscriber. The on-line content server identifies the subscriber by mapping the indicia of the sending device to a subscriber account. The on-line content server authenticates the subscriber if the subscriber is determined to have a valid account for purchasing content via SMS message request.

At step 208, the subscriber identifies the radio station (e.g. the radio frequency or call sign) and time information associated with the request and provides this information to the on-line content provider. This information may be provided coincident to step 204 or may be sent in separate message(s). Thus, in the case where the subscriber requests a song heard on the radio, the subscriber need not specify the title and artist of the song, but merely the radio station and timing information to enable the on-line content provider to determine the title and artist. The timing information may be automatically embedded in the SMS messages sent from the wireless communication device 102 or, optionally, may be separately entered by the subscriber. For example, in the case where the subscriber requests a song currently playing on the radio, the time information may comprise the current time of day or “system” time embedded in the initial request; or in the case where the subscriber requests past or future content, the time information may comprise a time window to look forward or look back for the requested content.

At step 210, the on-line content server 104 receives the message(s) and queries the appropriate radio station web server 124 to identify specific content. That is, based on the radio station and timing information, the on-line content server queries the radio station web server to more specifically identify the content. In one embodiment, the on-line content server 104 looks up the IP address or URL for the web server 124 for the specified radio station and launches a SOAP message to the web server 124 requesting the content played at the time of request. The radio station web server 124 receives the request, looks up the play list and at step 212, sends specific content information to the on-line content server 104. In such manner, for example, the on-line content server may determine the title and artist for a song played at the time of the request; or the title and artist of one or more songs played within a designated time window.

Having received the specific content information from the radio station, the on-line content server 104 determines content, purchase and/or delivery options at step 214. It is envisioned, for example, that some content played on the radio may not be available for purchase from the on-line content server 104. Some content may be available in different forms or formats, possibly for different prices. For example, in the case where the content is a particular song, the purchase options may include a free 30-second “preview,” an individual song download, an entire album download or perhaps a music video. Delivery options may comprise, for example, downloads to the subscriber's wireless communication device 102 or PC 112. The delivery options may be specified at time of service provisioning with the on-line service provider or may be specified via one or more messages coincident to each request. As will be appreciated, delivery options may include various enhancements such as e-mail notification to inform the subscriber that the purchased song has been downloaded (or is available for download) to a particular device.

At step 216, the on-line content server sends a message to the subscriber including one or more items of content information, purchase information and/or delivery information. This information may comprise, for example, a list of content, purchase and/or delivery options. In one embodiment, for example, the on-line content server sends an SMS message to the subscriber's wireless communication device 102 indicating particular content (e.g., the title and artist of song files) available for purchase. The SMS message may also include price information and delivery options associated with the content options.

At step 218, the subscriber selects one or more items of content and a delivery option (so as to request/confirm purchase of the content via the designated delivery option) and returns an SMS message with this information to the on-line content server 104. The on-line content server 104 receives the message at step 220, causes the requested content to be downloaded (or made available for download) to a selected delivery device and charges the subscriber account as may be appropriate. At step 222, the on-line content server sends one or more messages (e.g., SMS message(s), e-mails or the like) to confirm the transaction.

For example, the delivery device may be the subscriber's PC or wireless communication device 102. In the case of the PC, it may not be possible to download the content to the PC until such time as the subscriber operates the PC to affirmatively initiate the download. In such case, the on-line content server does not download the content but makes the content available for download to the PC when initiated by the subscriber at the subscriber's convenience. The on-line content provider may send an e-mail notification confirming the transaction and indicating that the content is available for download. In the case where the delivery device is the wireless communication device, the on-line content server may download the content directly to the device 102 and send an SMS message to the device 102 confirming the transaction.

As will be appreciated, the method of FIG. 2 may be enhanced in various ways to improve the ease of using the service and/or to purchase different content. The concept may be extended beyond radio content, for example, to purchase content playing on television broadcast stations (e.g. music videos or DVD of movies or concert recordings) or other broadcast media. The broadcast stations can also include XM radio stations, cable TV stations and web casting sites. Moreover, the concept may be extended to purchase content or to request further information associated with advertisements heard on the radio or television. In such case, the subscriber's initial SMS message might be sent to a special redirection server that could be operated by the wireless carrier or a third party. This server would receive the subscriber's SMS message and launch a SOAP message to the web server for the specified broadcast station. The message would indicate that this is a request for more information or to purchase and item advertised at a specific time. The radio station web server could then pass this information on to the web server for the corresponding advertisement. The web server for the corresponding advertisement could then initiate an SMS dialog with the end user to complete the transaction.

Another possible enhancement is to use a pre-specified list of favorite radio stations to simplify the mechanism for identifying the radio station at step 208. For example the subscriber could specify in their user profile with the on-line content server a short list of their favorite radio stations. After the subscriber launches their initial request at step 204, the on-line content server could respond with an SMS message with a list of the subscriber's pre-specified favorite stations. The subscriber would be asked to select the radio station. As another example, the on-line content server may perform a search of the content played on the pre-specified stations, respond with an SMS message with a list of the content and ask the subscriber to select the desired content from the list.

Still another possible enhancement relates to identifying the radio station at step 208 based on the location of the wireless device 102. A single radio frequency can be assigned to multiple radio stations having large geographical separation. Consequently if the end user specifies the radio frequency they are listening to it is not possible to know exactly which station the user is listening to. Similarly if the user is watching a broadcast TV channel (e.g. channel 5) the designation of channel 5 does not uniquely identify the TV broadcast station. To resolve this ambiguity the on-line content server can send a location request to the wireless carrier that servers the subscriber's wireless communication device. The wireless carrier would respond to that request with the current geographic coordinates of the wireless communication device. The on-line content server can then use the radio frequency and location to determine which radio station (or TV station) the subscriber is listening to.

FIG. 3 is a flowchart of a method that may be implemented in a communication system of the type shown in FIG. 1 for a subscriber 114 to acquire music or other content from an on-line content provider via a wireless communication device 102 specifying the title/artist.

The method presumes at block 302, that the subscriber 114 subscribes to an on-line content service, thereby establishing an account with an on-line service provider that enables the subscriber to access and purchase on-line content from the wireless communication device 102. In one embodiment, the on-line service allows the subscriber to request the purchase of content via SMS messages. For security the subscriber will specify the telephone number of the wireless communication device 102 that will launch the SMS messages. In one embodiment, the on-line content server 104 is equipped with software that allows it to receive SMS messages and to launch SOAP based XML information requests to a prescribed list of radio station web sites. The on-line content server 104 is also equipped to receive the response to those messages and to format SMS responses to the end user.

At step 304, the subscriber 114 initiates one or more SMS messages to the on-line content server 104 that specifies particular radio content (e.g., title and artist of a song, or radio program) desired for purchase. In one embodiment, the wireless communication device captures information embedded in the radio broadcast to identify the title and artist and includes this information in the SMS messages sent to the content server 104. Alternatively, such information can be manually entered by the subscriber into the wireless communication device and forwarded to the content server 104. In one embodiment, the SMS messages include indicia of the sending device 102, such as sending address, MIN number, telephone number or the like.

At step 306, the on-line content server 104 receives the message and authenticates the subscriber. The on-line content server identifies the subscriber by mapping the indicia of the sending device to a subscriber account. The on-line content server authenticates the subscriber if the subscriber is determined to have a valid account for purchasing content via SMS message request.

At step 308, the on-line content server identifies specific content corresponding to the title and artist information received at step 306. Generally, this may be accomplished by a straightforward mapping of the title and artist information to a database entry uniquely identifying a particular song. Occasionally, however, ambiguities may arise due to errors in the title or artist information or multiple entries corresponding to a particular title and artist. In such case, the on-line content server may query the subscriber for additional information to identify the specific content.

At step 310, the on-line content server 104 determines content, purchase and/or delivery options. For example, in the case where the content is a particular song, the purchase options may include a free 30-second “preview,” an individual song download, an entire album download or perhaps a music video. Delivery options may comprise, for example, downloads to the subscriber's wireless communication device 102 or PC 112. The delivery options may be specified at time of service provisioning with the on-line service provider or may be specified via one or more messages coincident to each request. As will be appreciated, delivery options may include various enhancements such as e-mail notification to inform the subscriber that the purchased song has been downloaded (or is available for download) to a particular device.

At step 312, the on-line content server sends a message to the subscriber including one or more items of content information, purchase information and/or delivery information. This information may comprise, for example, a list of content, purchase and/or delivery options. In one embodiment, for example, the on-line content server sends an SMS message to the subscriber's wireless communication device 102 indicating particular content (e.g., the title and artist of song files) available for purchase. The SMS message may also include price information and delivery options associated with the content options.

At step 314, the subscriber selects one or more items of content and a delivery option (so as to request/confirm purchase of the content via the designated delivery option) and returns an SMS message with this information to the on-line content server 104. At step 316, the on-line content server causes the requested content to be downloaded (or made available for download) to a selected delivery device and charges the subscriber account as may be appropriate. At step 318, the on-line content server sends one or more messages (e.g., SMS message(s), e-mails or the like) to confirm the transaction.

As will be appreciated, the method of FIG. 3 may be enhanced in various ways to improve the ease of using the service and/or to purchase different content. The method may be enhanced, for example, to provide for purchasing content playing on television broadcast stations or other broadcast media; or to purchase content or to request further information associated with advertisements heard on the radio or television, such as described in relation to FIG. 2.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method, performed by a wireless communication device in communication with an on-line content server, to request on-line content corresponding to broadcast programming, the method comprising:
sending a message including source and timing information associated with broadcast programming for which corresponding on-line content is desired; and
receiving indicia of one or more items of on-line content identified by the on-line content server based on the source and timing information.

2. The method of claim 1, performed to request on-line content corresponding to a song played on the radio, the method comprising:
sending indicia of a radio station on which the song was played and a specified time the song was played; and
receiving indicia of one or more items of on-line content corresponding to the song played by the radio station at the specified time.

3. The method of claim 2, wherein the step of receiving indicia comprises receiving indicia of a song file corresponding to the song played by the radio station at the specified time.

4. The method of claim 3, further comprising receiving indicia of one or more purchase options associated with the song file, the method further comprising:
responsive to user selection, identifying a selected purchase option;
sending a message including indicia of the selected purchase option; and
receiving at least a portion of the song file corresponding to the selected purchase option.

5. The method of claim 3, further comprising receiving indicia of one or more delivery options associated with the song file, the method further comprising:
responsive to user selection, identifying a selected delivery option, the selected delivery option designating a specified delivery device;
sending a message including indicia of the selected delivery option; and
receiving at least a portion of the song file corresponding to the selected purchase option at the specified delivery device.

6. The method of claim 1, further comprising receiving indicia of one or more purchase options associated with the on-line content, the method further comprising:
responsive to user selection, identifying a selected purchase option;
sending a message including indicia of the selected purchase option; and
receiving one or more items of on-line content corresponding to the selected purchase option.

7. The method of claim 6, further comprising receiving indicia of one or more delivery options associated with the on-line content, the method further comprising:
responsive to user selection, identifying a selected delivery option, the selected delivery option designating a specified delivery device;
sending a message including indicia of the selected delivery option; and
receiving one or more items of on-line content corresponding to the selected purchase option at the specified delivery device.

8. The method of claim 7, wherein the delivery options include an option to deliver the on-line content to the wireless communication device.

9. The method of claim 7, wherein the delivery options include an option to deliver the on-line content to a designated computing device.

10. The method of claim 1, performed by the wireless communication device exchanging one or more SMS messages with the on-line content server.

11. A method, performed by a wireless communication device in communication with an on-line content server, to request on-line content corresponding to a song played on the radio, the method comprising:
sending a message including title and artist information associated with the song for which corresponding on-line content is desired; and
receiving indicia of one or more items of on-line content identified by the on-line content server based on the title and artist information.

12. A method performed by an on-line content server comprising:
receiving, from a wireless communication device, a message including source and timing information associated with broadcast programming;
based on the source and timing information, identifying one or more items of on-line content corresponding to the broadcast programming;
sending, to the wireless communication device, indicia of the one or more items of on-line content.

13. The method of claim 12, wherein the step of receiving a message comprises receiving a request for on-line content corresponding to a song played on the radio, the source and timing information comprising indicia of the radio station on which the song was played and a specified time the song was played, the step of identifying comprising:
querying a web server associated with the radio station to determine the song played by the radio station at the specified time;
identifying one or more items of on-line content corresponding to the song played by the radio station at the specified time.

14. The method of claim 13, wherein the step of identifying comprises identifying a song file corresponding to the song played by the radio station at the specified time.

15. The method of claim 14, further comprising sending indicia of one or more purchase options associated with the song file, the method further comprising:
receiving a message including indicia of a selected purchase option; and
sending at least a portion of the song file corresponding to the selected purchase option.

16. The method of claim 14, further comprising sending indicia of one or more delivery options associated with the song file, the method further comprising:
receiving a message including indicia of a selected delivery option, the selected delivery option designating a specified delivery device; and
sending at least a portion of the song file corresponding to the selected purchase option to the specified delivery device.

17. The method of claim 12, further comprising sending indicia of one or more purchase options associated with the on-line content, the method further comprising:
receiving a message including indicia of a selected purchase option; and
sending one or more items of on-line content corresponding to the selected purchase option.

18. The method of claim 17, further comprising sending indicia of one or more delivery options associated with the on-line content, the method further comprising:
receiving a message including indicia of a selected delivery option, the selected delivery option designating a specified delivery device; and
sending one or more items of on-line content corresponding to the selected purchase option to the specified delivery device.

19. The method of claim 18, wherein the specified delivery device is the wireless communication device, the step of sending comprising sending one or more items of on-line content corresponding to the selected purchase option to the wireless communication device.

20. The method of claim 18, wherein the specified delivery device is a designated computing device, the step of sending comprising sending one or more items of on-line content corresponding to the selected purchase option to the designated computing device.
